(19) United States
(12) Patent Application Publication
(10) Pub. No.: US 2010/0054233 A1
(43) Pub. Date: Mar. 4, 2010

(54) METHOD FOR SYNCHRONIZATION IN WIRELESS COMMUNICATION SYSTEM

(76) Inventors: Kyung Won PARK, Gyeonggi-do (KR); Won Gi Jeon, Gyeonggi-do (KR); Jong Ho Paik, Gyeonggi-do (KR); Suk Pil Lee, Gyeonggi-do (KR); Yong Soo Cho, Seoul (KR); Chang Hwan Park, Seoul (KR); Yo Han Ko, Seoul (KR)

Correspondence Address: North Star Intellectual Property Law, PC, P.O. Box 34688, Washington DC, DC, 20043, US

(21) Appl. No.: 12/346,724

(22) Filed: Dec. 30, 2008

(30) Foreign Application Priority Data
Aug. 29, 2008 (KR) 10-2008-0085376

(51) Int. Cl. H04J 3/06

(52) U.S. Cl. 370/350

(57) ABSTRACT

A synchronization method is provided. In the synchronization method, a first mutual ranging symbol is transmitted to at least one other subscriber station. A second mutual ranging symbol is received from the other subscriber station. Uplink synchronization information is controlled on the basis of the second mutual ranging symbol.

### CROSS-REFERENCE TO RELATED APPLICATIONS

This application claims the benefit under 35 U.S.C. 119(a) to Korean Patent Application No. 10-2208-0085376, filed on Aug. 29, 2008, the disclosure of which is incorporated herein by reference in its entirety.

### TECHNICAL FIELD

The following description relates to a wireless communication system, and in particular, to a method for synchronization in a wireless communication system.

### BACKGROUND

With the widespread use of the Internet, notebook computers, and mobile communication devices, users require mobility and remoteness in indoor or outdoor environments defined by spaces or buildings, such as, offices, stores and houses. Indoor wireless communication has advanced on the basis of, for example, a wireless LAN technology. The wireless LAN technology has rapidly advanced by the standardization of IEEE 802.11. Other examples of the wireless communication technology include ETSI HIPERLAN/2, HomeRF, and Bluetooth.

In the wireless communication, providing bi-directional communication by division between an Up-Link (UL) and a Down-Link (DL) is called duplexing. Examples of the duplexing scheme include a Frequency Division Duplexing (FDD) scheme, a Time Division Duplexing (TDD) scheme, and a Zipper scheme.

The FDD scheme performs communication by dividing UL transmission and DL transmission by frequency bands. The resource amount of the FDD scheme in one frame may be expressed as Equation (1) below.

C_{FDD}=(BW−F_{Guard})·(T_{Frame}−N_{Sym}·T_{CP}) (1)

where C_{FDD} denotes the resource amount of the FDD scheme, BW denotes the total band used, F_{Guard} denotes a guard band, T_{Frame} denotes the total frame length, N_{Sym} denotes the number of Orthogonal Frequency Division Multiplexing (OFDM) symbols in one frame, and T_{CP} denotes a Cyclic Prefix (CP) length.

The FDD scheme may be suitable for a system that is large in cell radius and supports a high-speed Subscriber Station (SS). However, the FDD scheme may need a guard band for division of a UL band and a DL band and require two Radio Frequency (RF) terminals. Also, the FDD scheme may have a limitation in coping with a UL/DL traffic change adaptively, because a UL/DL band size and an RF terminal are generally fixed.

The TDD scheme performs UL transmission and DL transmission at different times while using the same frequency band for the UL and DL transmissions. The resource amount of the TDD scheme in one frame may be expressed as Equation (2) below.

C_{TDD}=BW(T_{Frame}−(N_{Sym}·T_{CP})−T_{TTG}·T_{RTG}) (2)

where C_{TDD} denotes the resource amount of the TDD scheme, BW denotes the total band used, T_{Frame} denotes the total frame length, N_{Sym} denotes the number of OFDM symbols in one frame, T_{CP} denotes a CP length, and T_{TTG} and T_{RTG} denote a guard time between UL/DL links. The TDD scheme may easily cope with a UL/DL traffic change adaptively by changing a control signal without a separate RF terminal change. Because UL/DL signals are transmitted in the same band, UL/DL channels are symmetrical to each other. Thus, a Base Station (BS) can use channel information, estimated from an UL signal, in DL transmission, and an SS can use channel information, estimated from a DL signal, in UL transmission. However, the TDD scheme may need a guard time for division of the UL and the DL, and require a longer guard time because a propagation delay increases where a cell radius increases. Also, where a frame length increases, the TDD scheme generates a duplexing delay from DL transmission to UP transmission. This duplexing delay causes a transmission delay of a control channel and a response channel. Also, where the frame length increases, the performance degradation occurs due to a channel change between UL/DL links where channel information estimated in an UP process is used for DL signal transmission, or where channel information estimated in a DL process is used for UL signal transmission.

The Zipper scheme is a duplexing scheme used in wireless communication such as VDSL. The resource amount of the Zipper scheme may be expressed as Equation (3) below.

C_{zipper}=BW(T_{Frame}−N_{Sym}·(T_{CP}+T_{CS})) (3)

where C_{Zipper} denotes the resource amount of the Zipper scheme, BW denotes the total band used, T_{Frame} denotes the total frame length, N_{Sym} denotes the number of OFDM symbols in one frame, T_{CP} denotes a CP length, and T_{CS} denotes a Cyclic Suffix (CS) length.

The Zipper scheme does not need a guard band, and may easily cope with an UL/DL traffic change adaptively because it allocates UL/DL resources on an OFDM subcarrier basis. However, the Zipper scheme may not detect or control another user signal because Radio Frequency Interference (RFI) occurs in wired communication. In the wired communication, the RFI occurs in the form of Near End Cross-Talk (NEXT) and Far End Cross-Talk (FEXT) that are adjacent user interference due to coupling. This cross-talk problem generates ISI and ICI, thus destroying the orthogonality of UL/DL signals. Thus, the Zipper scheme maintains the signal orthogonality by using a CS that is a separate guard interval. Herein, because another user signal cannot be controlled and detected, the Zipper scheme uses a CS in consideration of the longest circuit length. The use of a CS degrades the resource efficiency in the Zipper scheme. In terms of hardware, because two Fast Fourier Transforms (FFTs) are used, the Zipper scheme requires a higher cost than the TDD scheme.

Accordingly, there is a need for a duplex synchronous data transmission method that may provide high flexibility in UL/DL resource allocation and provide high resource efficiency without causing or while preventing ISI and ICI.

### SUMMARY

Accordingly, according to an aspect, there is provided a synchronization method that provided high flexibility in uplink/downlink resource allocation and/or provides high resource efficiency without causing ISI and ICI.

According to another aspect, there is provided a synchronization method including transmitting a first mutual ranging symbol to at least one other subscriber station, receiving a second mutual ranging symbol from the other subscriber station, and controlling uplink synchronization information on the basis of the second mutual ranging symbol.

The synchronization method may further include performing an uplink synchronization with an access point before the transmitting of the first mutual ranging symbol.

The synchronization method may further include determining whether to insert a cyclic suffix in an Orthogonal Frequency Division Multiplexing (OFDM) symbol for data transmission on the basis of the controlled uplink synchronization information. The OFDM symbol may be configured to duplex a subcarrier for uplink transmission and a subcarrier for downlink transmission.

The synchronization method may further include transmitting data through the OFDM symbol, wherein the data are transmitted by performing a timing advance from an absolute time by the delay time with an access point on the basis of the controlled uplink synchronization information.

The synchronization method may further include transmitting data through the OFDM symbol, wherein the data are transmitted at a signal receiving time from an access point on the basis of the controlled uplink synchronization information.

The synchronization method may further include transmitting data through the OFDM symbol, wherein the data are transmitted by performing a variable timing advance on the basis of the controlled uplink synchronization information to minimize the maximum value of a delay time between an access point and the subscriber station according to an intra-cell environment.

If the sum of the maximum delay value of a channel impulse response, which is the largest one of channel impulse response lengths between an access point and the subscriber station and between the subscriber station and other subscriber stations, and the maximum value of a mutual delay time, which is the maximum mutual time delay difference, is smaller than or equal to a cyclic prefix length, the cyclic suffix may not to be inserted in the OFDM symbol, and if not, the cyclic suffix may be inserted in the OFDM symbol.

If the cyclic suffix is to be inserted in the OFDM symbol, a cyclic suffix with a length corresponding to the difference between the cyclic prefix length and the sum of the maximum delay value of the channel impulse response and the maximum value of the mutual delay time may be inserted in the OFDM symbol.

The mutual ranging symbol may include a plurality of preamble sequences, a cyclic prefix, and a cyclic suffix, or includes a preamble sequence, a cyclic prefix, and a cyclic suffix. The first mutual ranging symbol and the second mutual ranging symbol may be different in terms of the preamble sequence constituting the mutual ranging symbol.

The synchronization method may further include receiving timing information, for transmission of the first mutual ranging symbol, from an access point.

According to still another aspect, there is provided a data receiving method including performing initial ranging with a subscriber station to acquire uplink synchronization, and receiving uplink data from the subscriber station, wherein the uplink data are transmitted using uplink synchronization information controlled by exchanging mutual ranging symbols between intra-cell subscriber stations.

The date receiving method may further include determining whether to insert a cyclic suffix in an Orthogonal Frequency Division Multiplexing (OFDM) symbol for data transmission on the basis of the controlled uplink synchronization information.

Other features will become apparent to those skilled in the art from the following detailed description, which, taken in conjunction with the attached drawings, discloses exemplary embodiments of the invention.

### BRIEF DESCRIPTION OF THE DRAWINGS

FIGS. 1A and 1B are diagrams illustrating examples of wireless communication systems to which exemplary embodiments are applicable.

FIG. 2 is a diagram illustrating symbol structures in a frequency domain and a time domain according to an exemplary embodiment.

FIG. 3 is a flow diagram of a synchronization method according to an exemplary embodiment.

FIG. 4 is a diagram illustrating an example of a mutual ranging symbol according to an exemplary embodiment.

FIG. 5 is a diagram illustrating an example of an environment according to an exemplary embodiment.

FIG. 6A is a diagram illustrating a transmitting (TX) time and a receiving (RX) time in an AP and each SS where an exemplary Embodiment 1 is used in FIG. 5.

FIG. 6B is a diagram illustrating a TX time and an RX time in an AP and each SS where an exemplary Embodiment 2 is used in FIG. 5.

FIG. 6C is a diagram illustrating a TX time and an RX time in an AP and each SS where an exemplary Embodiment 3 is used in FIG. 5.

FIG. 7A is a diagram illustrating an exemplary Embodiment 4 not needing a CS.

FIG. 7B is a diagram illustrating an exemplary Embodiment 5 needing a CS.

FIG. 8A is a diagram illustrating an FFT window start point of an exemplary Embodiment 4.

FIG. 8B is a diagram illustrating an FFT window start point of an exemplary Embodiment 5.

FIG. 9 is a diagram illustrating estimation of a mutual delay time between each SS and another SS on the basis of a mutual ranging symbol according to an exemplary embodiment.

Throughout the drawings and the detailed description, unless otherwise described, the same drawing reference numerals will be understood to refer to the same elements, features, and structures. The elements may be exaggerated for clarity and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions are omitted to increase clarity and conciseness.

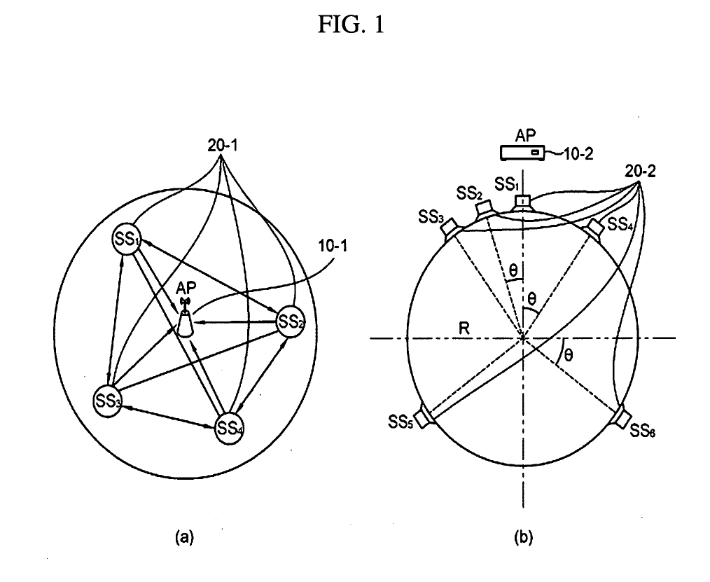

FIGS. 1A and 1B illustrate examples of wireless communication systems to which exemplary embodiments disclosed herein are applicable.

Referring to FIG. 1A, a basic service set of a wireless LAN system comprises an Access Point (AP) 10-1 and a plurality of Subscriber Stations (SSs) 20-1.

The AP 10-1 is a functional entity that provides an access to a Distribution System (DS) via a wireless medium for its own associated station (STA). In principle, communication between non-AP STAs is performed via the AP in the basic service set including the AP. However, where a direct link is set, direct communication is possible also between the non-AP STA. The AP may also be referred to as a centralized controller, a Base Station (BS), a node-B, a Base Transceiver System (BTS), or a site controller.

The SS 20-1 may be stationary or mobile. The SS may also be referred to as a non-AP STA, a Wireless Transmit/Receive Unit (WTRU), a User Terminal (UT), a User Equipment (UE), a Mobile Station (MS), a wireless device, a mobile terminal, or a mobile subscriber unit.

Referring to FIG. 1B, a basic service set of a wireless audio system comprises an AP 10-2 and a plurality of SSs 20-2. The AP 10-2 provides an access to a DS via a wireless medium for the SSs 20-2 associated with the AP 10-2 itself.

Because mutual time information and mutual channel information may need to be estimated for simultaneous transmission of Up-Link (UL) and Down-Link (DL), the exemplary embodiments may be desirably applied to a wireless environment where a cell radius is small, a small number of SSs are present, and each SS is very low in mobility as illustrated in FIGS. 1A and 1B. However, it is understood that the embodiments disclosed herein are not limited thereto. Hereinafter, the DL means transmission from the APs 10-1 and 10-2 and to the SSs 20-1 and 20-2, and the UL means transmission from the SSs 20-1 and 20-2 to the APs 10-1 and 10-2.

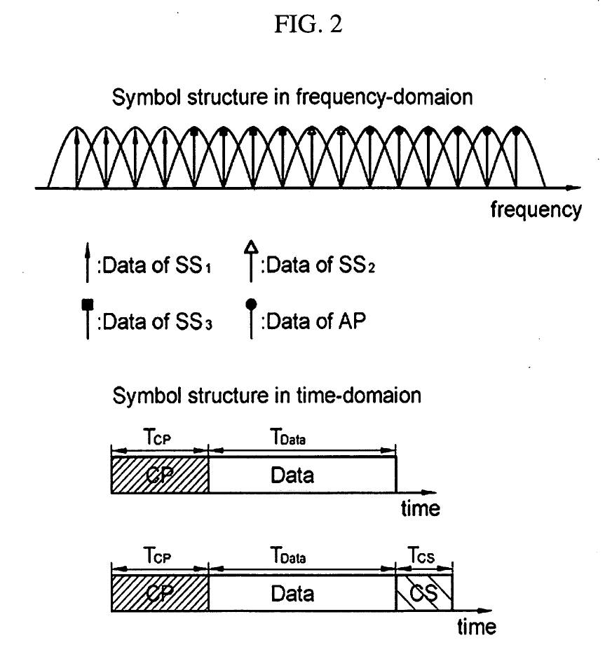

FIG. 2 illustrates symbol structures in a frequency domain and a time domain according to an exemplary embodiment.

Referring to FIG. 2, the exemplary embodiment uses an Orthogonal Frequency Division Multiple Access (OFDMA) scheme, and a time-domain symbol may include a Cyclic Prefix (CP) and data. Where Inter-Symbol Interference (ISI) and Inter-Carrier Interference (ICI) occur due to channel delay and mutual time delay, a time-domain symbol may include a CP, data, and a Cyclic Suffix (CS). Also, in the frequency domain, the OFDMA scheme is used to allocate a DL signal of an AP and an UL signal of an SS on a subcarrier-by-subcarrier basis. Because each subcarrier of an OFDMA symbol is orthogonal, an UL signal of each SS and a DL signal of an AP may be detected without mutual interference.

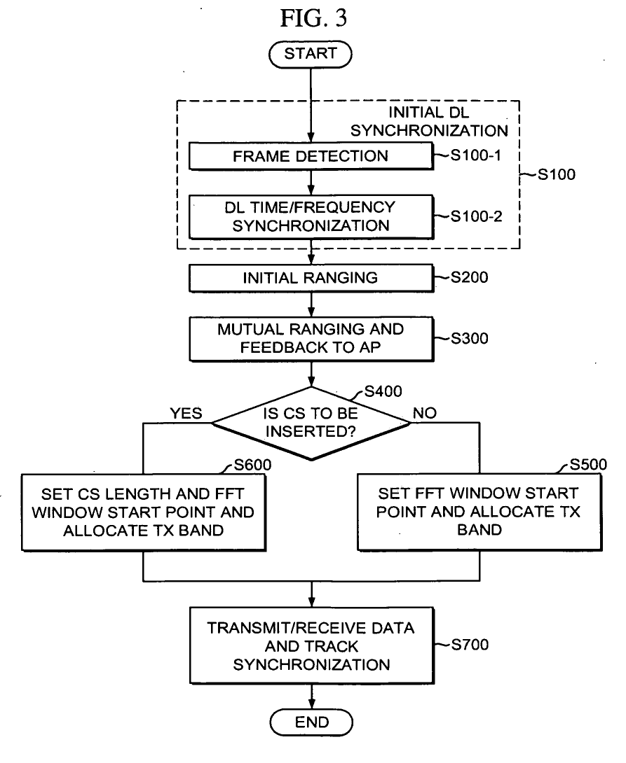

FIG. 3 is a flow diagram a synchronization method according to an exemplary embodiment.

Referring to FIG. 3, each SS performs initial DL synchronization in operation S100. The initial DL synchronization operation (S100) comprises a DL frame detection operation S100-L and a DL time/frequency synchronization operation S100-2. In the DL frame detection operation S100-1, each SS performs DL frame detection by using an auto-correlation or a cross-correlation by using a preamble or a training sequence. In the DL time/frequency synchronization operation S100-2, each SS performs DL time synchronization and DL frequency synchronization.

In operation S200, each SS performs initial ranging. For example, UL frequency synchronization and UL time synchronization between an AP and each SS are performed to estimate channel information and time synchronization information between the AP and each SS. Each SS transmits an initial ranging symbol to perform UL frequency synchronization and UL time synchronization between the AP and the SS. The initial ranging symbol may be two OFDMA symbols, a first OFDMA symbol including a CP and a preamble sequence and a second OFDMA symbol including a preamble sequence and a CS; or may be one OFDMA symbol including a CP, a preamble sequence, and a CS.

In operation S300, each SS performs mutual ranging and transmits information obtained by the mutual ranging to the AP. For example, each SS transmits a mutual ranging symbol, receives a mutual ranging symbol from another SS, and uses the same to estimate mutual channel information and mutual time synchronization information between the SS and another SS. For example, UL synchronization information is controlled using the mutual ranging symbol. The estimated mutual time synchronization information and mutual channel information are transmitted to the AP through a feedback channel. Thus, the mutual ranging symbol may be configured to identify a signal of each SS. In the mutual ranging operation S300, a time-division scheme, a frequency-division scheme, a phase-division scheme, a code-division scheme, or a combination thereof may be used to identify the respective mutual ranging symbols transmitted.

An example of the time-division scheme for transmission of the respective mutual ranging symbols is as follows. Each SS transmits a mutual ranging symbol at a given time. The mutual ranging symbol includes a symbol with a repetitive pattern so that time synchronization can be acquired by auto-correlation in the time domain using the mutual ranging symbol. Each SS transmits its own mutual ranging symbol of an orthogonal code at the same time, receives a mutual ranging symbol, and uses a cross-correlation technique to acquire time synchronization of another SS.

An example of the frequency-division scheme for transmission of the respective mutual ranging symbols is as follows. Each SS uses a different frequency domain for transmission. Each SS receives a mutual ranging symbol and sets an FFT interval in accordance with the time synchronization of the AP to demodulate the mutual ranging symbol. The demodulated mutual ranging symbol has a phase rotation in the frequency domain by the symbol timing offset with the AP. Thus, each SS may acquire the time synchronization of another SS in a cell with respect to the AP time synchronization acquired in the initial DL synchronization operation.

An example of the phase-division scheme for transmission of the respective mutual ranging symbols is as follows. Each SS uses the same code and multiplies each code by a different phase for transmission. Each SS receives a mutual ranging symbol of another SS and sets an FFT interval in accordance with the time synchronization of the AP to demodulate the mutual ranging symbol. The demodulated mutual ranging symbol is divided by an original code to obtain a frequency response of a channel, and the frequency response is IFFT-processed to obtain an impulse response that is circularly shifted by the sum of a symbol timing offset and a phase multiplied by each SS. Where the size of the first tap of the channel is largest, the time synchronization of another first-received SS with respect to the AP time synchronization may be acquired by detecting a portion with the largest value.

An example of the mutual ranging step of the respective SSs by transmission/reception of the mutual ranging symbols is as follows. In the mutual ranging step, an estimated delay time and channel must be accorded with a TX SS on the basis of a signal received to estimate mutual time synchronization information and mutual channel information. Equation (4) below expresses an example of the mutual ranging symbol that is obtained by modulating each mutual ranging symbol by the same code C(k) and phase-shifting a frequency-domain signal by the specific phase to identify each SS.

Xᵢ(k)=C(k)e^{-j2π(m·(i-1))k/N}

xᵢ(n)=c(n−m·(i−1)) (4)

where k=0,1, . . . , N−1, i=1,2, . . . , N_{SS}, m>2RTD+τ_{Channel}

where N_{SS} denotes the number of SSs, i denotes an SS number, and m denotes a phase difference index between the respective SSs. Herein, m is determined in consideration of a Round Trip Delay (RTD) and a maximum channel delay τ_{Channel}.

Where a phase-rotated frequency-domain signal Xᵢ(k) is represented in a time-domain signal xᵢ(n) by Inverse Fast Fourier Transform (IFFT), the time-domain signal xᵢ(n) is equivalent to a signal obtained by circularly shifting c(n) by m·(i−1). A mutual ranging symbol transmitted by each SS is received simultaneously by different SSs through different channels. A signal received by each SS may be expressed as Equation (5) below.

$${y}_{j} ( n ) = {\sum }_{i = 1}^{{N}_{SS}} {x}_{i} ( n - {T}_{i , j} ) ⊗ {h}_{i , j} ( n ) + {w}_{i , j} ( n ) for i \neq j \qquad ( 5 )$$

where yⱼ(n) denotes a time-domain signal received by the j^{th} SS, \textcircled{x} denotes convolution, h_{i,j}(n) and w_{i,j}(n) respectively denote a channel impulse response and a noise between the i^{th} SS and the j^{th} SS, and T_{i,j} denotes a delay time between the i^{th} SS and the j^{th} SS.

In order to obtain mutual time synchronization information and inter-link channel information from a received time-domain signal, a received signal is FFT-processed and the result is divided by an original code C(k) to obtain a channel value. Herein, the code C(k) is already known to each SS. Because each SS multiplies a signal by a different phase m·(i−1) prior to transmission, when a signal divided by C(k) is IFFT-processed, a channel response of each signal is circularly shifted in the time domain by the multiplied phase. Also, a phase delay of T_{i,j} occurs in the phase of each SS. A process of estimating mutual time synchronization information and channel information in each SS by using a received signal may be expressed as Equation (6) below.

$${y}_{j} ( k ) = {\sum }_{i = 1}^{{N}_{SS}} {X}_{i} ( k ) {H}_{i , j} ( k ) {e}^{- j 2 π {T}_{i , j} k / N} + {W}_{i , j} ( k ) for i \neq j \\ \begin{matrix}{\hat{H}}_{j} ( k ) = {Y}_{j} ( k ) / C ( k ) \\ = {\sum }_{i = 1}^{{N}_{SS}} {H}_{i , j} ( k ) {e}^{- j 2 π ( m \cdot ( i - 1 ) + {T}_{i , j} ) k / N} + \frac{{W}_{i , j} ( k )}{C ( k ) } for i \neq j \\ = {\sum }_{i = 1}^{{N}_{SS}} {H}_{i , j} ( k ) {e}^{- j 2 π ( m \cdot ( i - 1 ) + {T}_{i , j} ) k / N} + {\tilde{W}}_{i , j} ( k ) \end{matrix} \\ {\hat{h}}_{j} ( n ) = {\sum }_{i = 1}^{{N}_{SS}} {h}_{i , j} ( n - ( m \cdot ( i - 1 ) + {T}_{i , j} ) ) + {\tilde{w}}_{i , j} ( n ) for i \neq j \qquad ( 6 )$$

where Ĥⱼ(k) denotes a channel value estimated in the frequency domain, and ĥⱼ(n) denotes a channel impulse response circularly shifted by (m·(i−1)+T_{i,j}). Herein, because each SS already knows the occurrence of a circular shift of by m·(i−1) from the specific phase rotation of another SS, a mutual delay time may be estimated by detecting the degree of an additional circular shift to the specific circular shift m·(i−1) of each SS from the channel impulse response.

As another example, the time synchronization information and channel information between the AP and each SS may be estimated.

In operation S400, the AP selects a transmission scheme on the basis of the received mutual time synchronization information and channel information and determines if a CS is to be inserted. If the CS is not to be inserted (in operation S400), the synchronization method proceeds to operation S500. In operation S500, the AP sets an FFT window start point of each SS and the AP and allocates a TX band. The AP transmits the set values to each SS through a DL control channel.

Thereafter, in operation S700, the AP and each SS transmit/receive data symbols and tracks synchronization. Specifically, each data is inserted at the allocated time and subcarrier, and an OFDMA symbol containing a CP and data is generated and transmitted. Then, the AP and each SS FFT-process received signals at a given FFT start point to detect the received signals. While transmitting the data symbols, the AP and each SS uses a pilot subcarrier to track UL/DL time and frequency synchronization and mutual synchronization. For example, a preamble, an initial ranging symbol, and a mutual ranging symbol are transmitted to track the synchronization.

If the CS is to be inserted (in operation S400), the synchronization method proceeds to operation S600. In operation S600, using the estimated mutual time synchronization information and mutual channel information, the AP sets a CS length and an FFT window start point of each SS and the AP and allocates a TX band. The AP transmits the set values to each SS through a DL control channel.

Thereafter, in operation S700, the AP and each SS transmit/receive data symbols and tracks synchronization. Specifically, each data is inserted at the allocated time and subcarrier, and an OFDMA symbol containing a CP and data is generated and transmitted. Then, the AP and each SS FFT-process received signals at a given FFT start point to detect the received signals. While transmitting the data symbols, the AP and each SS uses a pilot subcarrier to track UL/DL time and frequency synchronization and mutual synchronization. For example, a preamble, an initial ranging symbol, and a mutual ranging symbol are transmitted to track the synchronization.

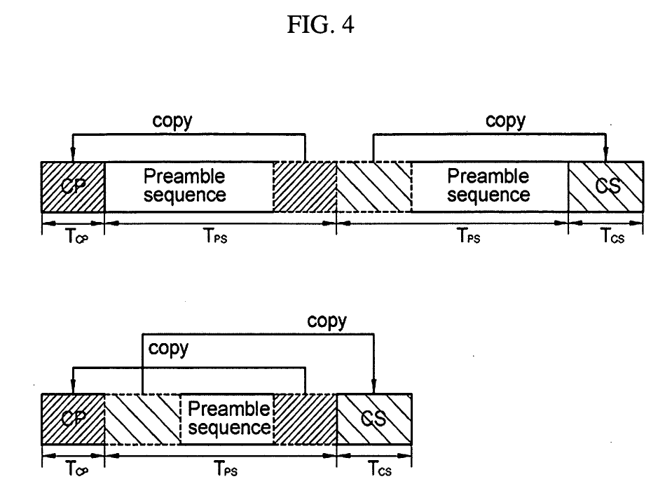

FIG. 4 illustrates an example of a mutual ranging symbol according to an exemplary embodiment.

Referring to FIG. 4, in order to prevent ISI and ICI that may occur due to a mutual time delay difference between respective symbols, the mutual ranging symbol may be two OFDMA symbols, a first OFDMA symbol including a CP and a preamble sequence and a second OFDMA symbol including a preamble sequence and a CS; or may be one OFDMA symbol including a CP, a preamble sequence, and a CS.

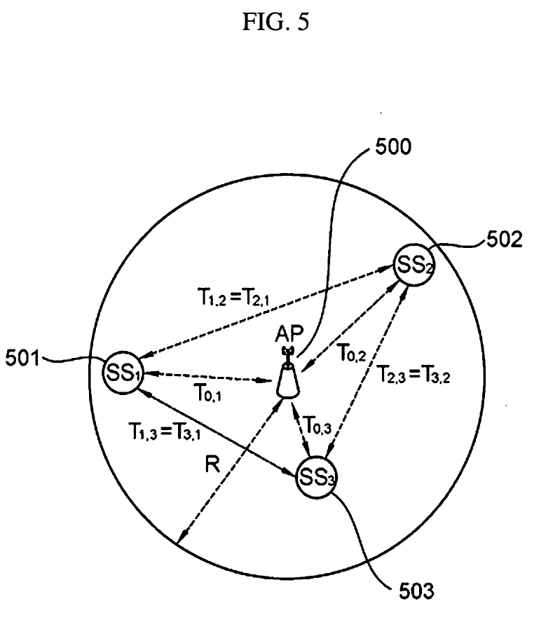

FIG. 5 illustrates an example of an environment according to an exemplary embodiment.

Referring to FIG. 5, a cell with a radius R includes an AP 500 and three SSs 501 to 503. Herein, T_{i,j} denotes a delay time between the i^{th} SS and the j^{th} SS, and an index of the AP 500 is represented by a subscript 0. As illustrated in FIG. 5, a time delay between each SS and another SS is estimated to obtain mutual time synchronization information. As another example, a time delay between the AP and each SS may be estimated.

Hereinafter, a description will be given of an exemplary Embodiment 1, Embodiment 2, and Embodiment 3 (Embodiment 3-1 and Embodiment 3-2) that are classified according to the TX times in the AP and each SS.

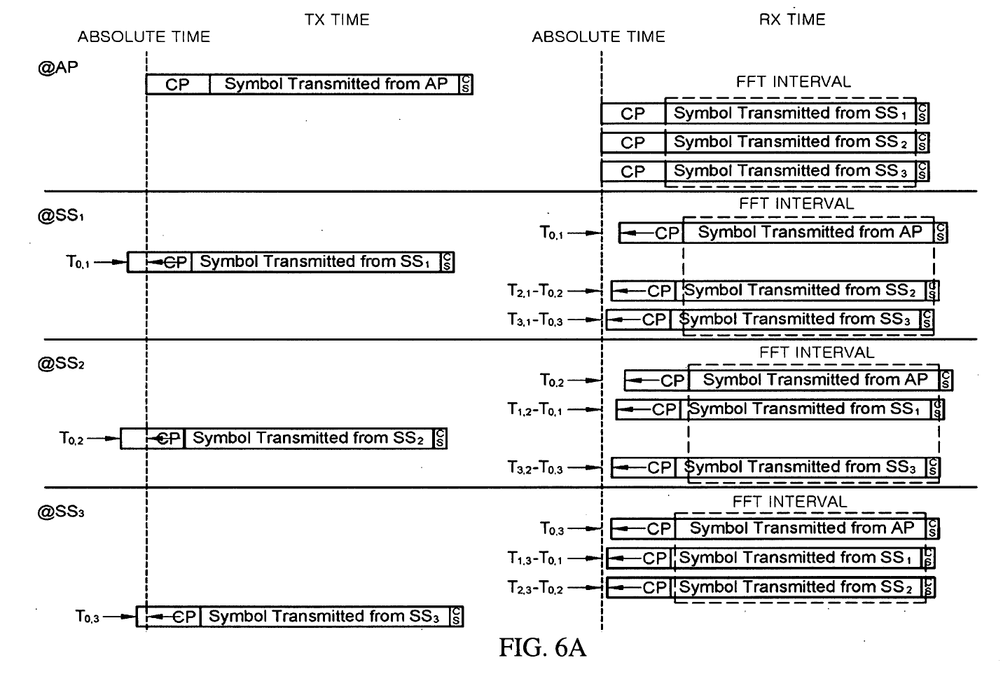

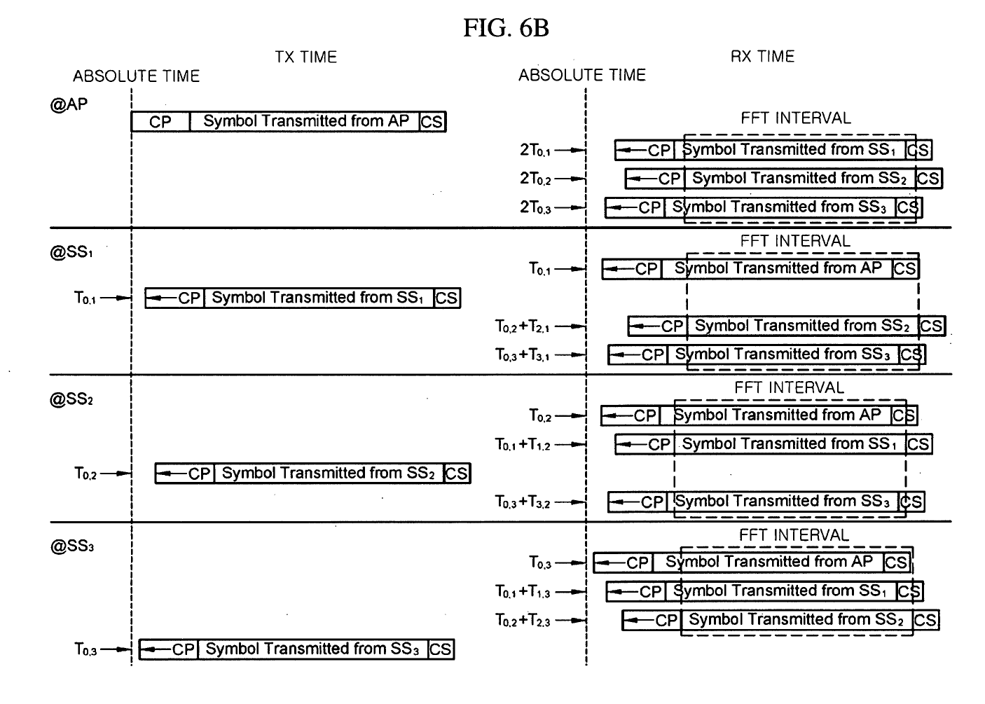

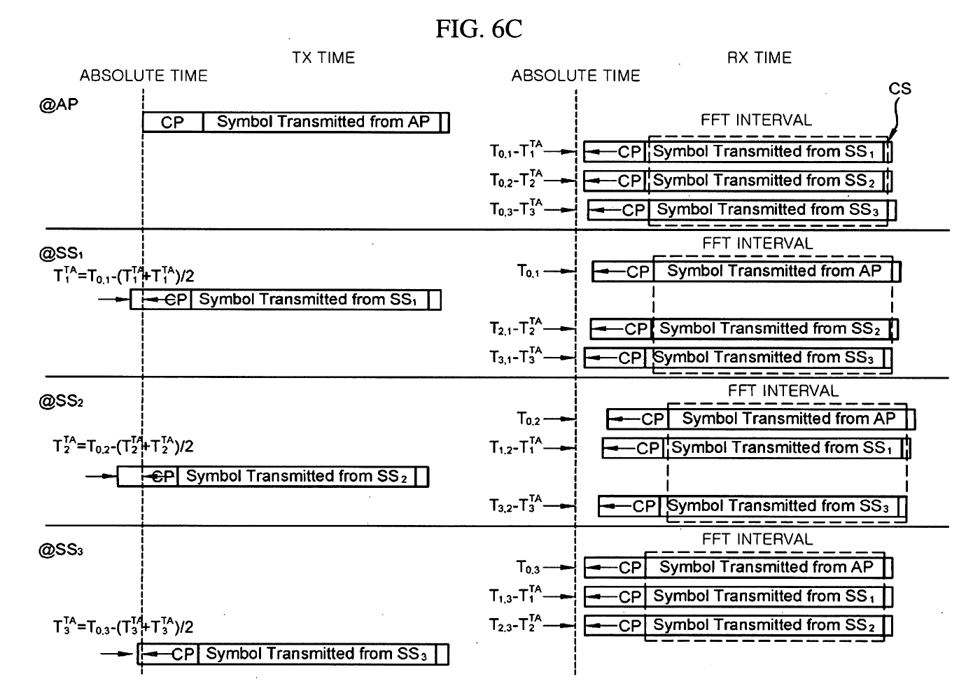

FIG. 6A is a diagram illustrating a TX time and an RX time in the AP and each SS where an exemplary Embodiment 1 is used in FIG. 5. Herein, it is assumed that a channel impulse response length is equal to a CP length, and a CS corresponding to a maximum mutual delay time difference is inserted in all the symbols.

Referring to FIG. 6A, T_{i,j} denotes a delay time between the i^{th} SS and the j^{th} SS, and Tᵢ^{TA} denotes a timing-advanced value in the i^{th} SS. Herein, an AP index is represented by a subscript 0. As illustrated in FIG. 6, in Embodiment 1, each SS performs transmission with the timing advance from an absolute time by the time difference between the AP and each SS, and a data symbol transmitted by each SS is received by the AP at the same time. Each SS receives a signal of the AP always later than another SS. Herein, each SS acquires the time synchronization of another SS in a mutual ranging step and resets an FFT interval in accordance with the first-received SS signal to perform signal demodulation without ISI and ICI. Also, inter-SS mutual channel information is obtained through a mutual ranging operation and it may be used as optimal resource allocation information. If the cell radius is set to R, a delay time difference in Embodiment 1 is from 0 to 2T (T=R[m]×3.3[ns/m]).

FIG. 6B is a diagram illustrating a TX time and an RX time in the AP and each SS where an exemplary Embodiment 2 is used in FIG. 5. Herein, it is assumed that a channel impulse response length is equal to a CP length, and a CS corresponding to a maximum mutual delay time difference is inserted in all the symbols.

Referring to FIG. 6B, unlike Embodiment 1, Embodiment 2 transmits a symbol of each SS in synchronization with the time of receiving an AP signal by each SS, without performing a timing advance in consideration of a delay time from each SS and the AP. The AP receives a signal of each SS with a time difference two times larger than a delay time between the AP and each SS, and each SS receives a signal of the AP always earlier than another SS. Herein, each SS sets an FFT interval in accordance with the time synchronization of the AP, acquired in an initial DL synchronization step, to perform signal demodulation without ISI and ICI. However, a mutual ranging operation must be performed to obtain channel information of all the links. If the cell radius is set to R, a delay time difference in Embodiment 2 is from 0 to 4T (T=R[m]×3.3[ns/m]).

FIG. 6C is a diagram illustrating a TX time and an RX time in the AP and each SS where an exemplary Embodiment 3 is used in FIG. 5. Herein, it is assumed that a channel impulse response length is equal to a CP length, and a CS corresponding to a maximum mutual delay time difference is inserted in all the symbols.

Referring to FIG. 6C, Embodiment 3 performs a variable timing advance for transmission in order to minimize a maximum delay time in the AP and each SS. Thus, Embodiment 3 has a smaller maximum delay time than Embodiment 1 and Embodiment 2.

Embodiment 3 may be divided into Embodiment 3-1 and Embodiment 3-2 according to methods for minimizing the maximum delay time difference.

Embodiment 3-1 detects a TX time in consideration of all the possible TX times in order to minimize the maximum delay time difference between the AP and each SS in the cell. Embodiment 3-1 may be expressed as Equation (7) below.

T^{TA}=arg min_{\tilde{T}}{f(\tilde{T})} (7)

where T^{TA}=[T₀^{TA}, T₁^{TA}, T₂^{TA}, . . . , T_{N}_{_{SS}}^{TA}], \tilde{T}=[\tilde{T}₀, \tilde{T}₁, \tilde{T}₂, . . . , \tilde{T}_{N}_{_{SS}}]

where T^{TA} is a vector representing a timing-advanced TX time estimated in Embodiment 3-1, f(\tilde{T}) is a function representing the maximum delay time difference between the AP and each SS where transmission is performed with a timing advance of \tilde{T}, Tᵢ^{TA} denotes an estimated timing-advanced TX time in the AP or each SS, and \tilde{T}ᵢ denotes a timing-advanced TX time.

Embodiment 3-1 detects a TX time minimizing a function f(T) representing the maximum delay time difference between the AP and each SS while changing the value of a vector \tilde{T} including a timing-advanced TX time. If the number of SSs is N_{SS}, Embodiment 3-1 requires computation times of (N_{SS}+1)! per vector \tilde{T}. That is, the computational complexity of Embodiment 3-1 increases with an increase in the vector \tilde{T} and the number of SSs.

Embodiment 3-2 detects a TX time of each SS to minimize the maximum delay time difference between the AP and each SS in the cell, which detects a TX time of each SS independently. A timing advance value of each SS in Embodiment 3-2 may be expressed as Equation (8) below.

Tᵢ^{TA}=T_{0,j}−(Tᵢ^{max}+Tᵢ^{min})/2

where Tᵢ^{max}=(T_{i,j}−T_{0,j})ₘₐₓ

Tᵢ^{min}=(T_{i,k}−T_{0,k})ₘᵢₙ (8)

i, j, k ∈ {SS₁, SS₂, . . . , SS_{N}_{_{SS}}}, i≠j, i≠k
where T^{TA} denotes a timing advance value of the i^{th} SS estimated by an Embodiment 3-2 method, T_{0,j} denotes a delay time value between the AP and the j^{th} SS, T_{i,j} denotes a delay time value between the i^{th} S and the j^{th} SS, Tᵢ^{max} denotes the largest one of delay time differences with AP signals received from other SSs where a signal is transmitted from the i^{th} SS to other SSs in an Embodiment 1 method, and Tᵢ^{min} denotes the smallest one of delay time differences with AP signals received from other SSs where a signal is transmitted from the i^{th} SS to other SSs in the Embodiment 1 method.

Because signals of all the SSs are received always earlier than a signal of the AP in a transmission scheme of Embodiment 1, the maximum delay time difference between the AP and each SS may be reduced by delaying the TX time of each SS by (Tᵢ^{max}+Tᵢ^{min})/2. If the cell radius is set to R, a delay time difference in Embodiment 3 is from 0 to 2T (T=R[m]×3.3[ns/m]).

Hereinafter, a description will be given of Embodiment 4 and Embodiment 5 that depend on whether a CS is to be inserted in the embodiments.

In the embodiments, ISI and ICI may occur due to a mutual time difference between respective RX signals. However, there is a case where ISI and ICI do not occur even if the mutual time difference occurs. In this case, it is not necessary to insert the CS. In the embodiments, mutual time synchronization information and mutual channel information estimated in a mutual ranging process are used to determine whether to insert the CS.

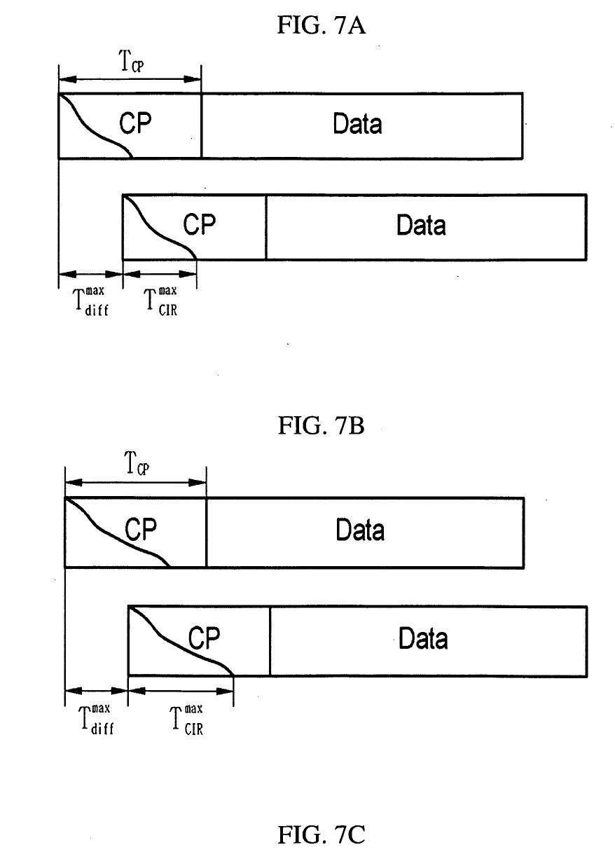

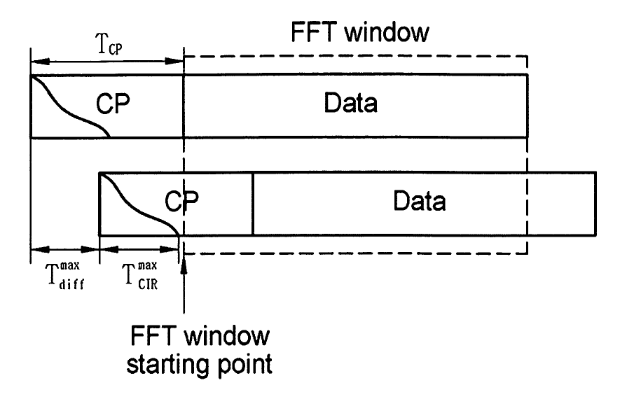

FIG. 7A is a diagram illustrating an exemplary Embodiment 4 not needing a CS. FIG. 7B is a diagram illustrating an exemplary Embodiment 5 needing a CS.

Referring to FIG. 7A, Embodiment 4 corresponds to a case where the sum of the maximum delay value of a channel impulse response and the maximum value of a mutual delay time is smaller than or equal to the CP length. Referring to FIG. 7B, Embodiment 5 corresponds to a case where the sum of the maximum delay value of a channel impulse response and the maximum value of a mutual delay time is larger than the CP length. Equation (9) below illustrates Embodiment 4 and Embodiment 5.

Embodiment 4: T_{CP}≧T_{CIR}^{max}+T_{diff}^{max}

Embodiment 5: T_{CP<}T_{CIR}^{max}+T_{diff}^{max} (9)

where T_{CP} denotes the CP length, T_{CIR}^{max} denotes the largest one of the channel impulse response lengths between the AP and each SS and between each SS and other SSs, and T_{diff}^{max} denotes the maximum mutual time delay difference in the cell.

Embodiment 4 may maintain the orthogonality of an OFDMA symbol without use of a CS because an effect of a previous symbol due to a channel delay and an effect of another symbol due to a mutual time delay are included in a CP interval.

Because an effect of a previous symbol due to a channel delay and an effect of another symbol due to a mutual time delay are not included in a CP interval, Embodiment 5 must insert a CS corresponding to (T_{CIR}^{max}+T_{diff}^{max}−T_{CP}) in order to maintain the orthogonality of OFDMA symbols. That is, because the CS length is 0 in Embodiment 4, the AP and each SS must transmit/receive an OFDMA symbol including a CP and data. In this case, the orthogonality of the OFDMA symbol is maintained, and thus a data symbol may be detected without the performance degradation due to ISI and ICI.

In the case of Embodiment 5, the CS length is (T_{CIR}^{max}+T_{diff}^{max}−T_{CP}), and the AP and each SS transmit/receive an OFDMA symbol including a CP, data, and a CS. The orthogonality of the OFDMA symbol is maintained by the use of the CS, and thus a data symbol may be detected without the performance degradation due to ISI and ICI. However, even in the case of Embodiment 5, an OFDMA symbol may include only a CP and data, or may include a CP, data, and a CS with a length smaller than the CS length (T_{CIR}^{max}+T_{diff}^{max}−T_{CP}). In this case, the performance degradation may be caused by the non-satisfaction of the orthogonality of the OFDMA symbol.

Hereinafter, a description will be given of an exemplary method of setting an FFT window start point of Embodiment 4 and Embodiment 5.

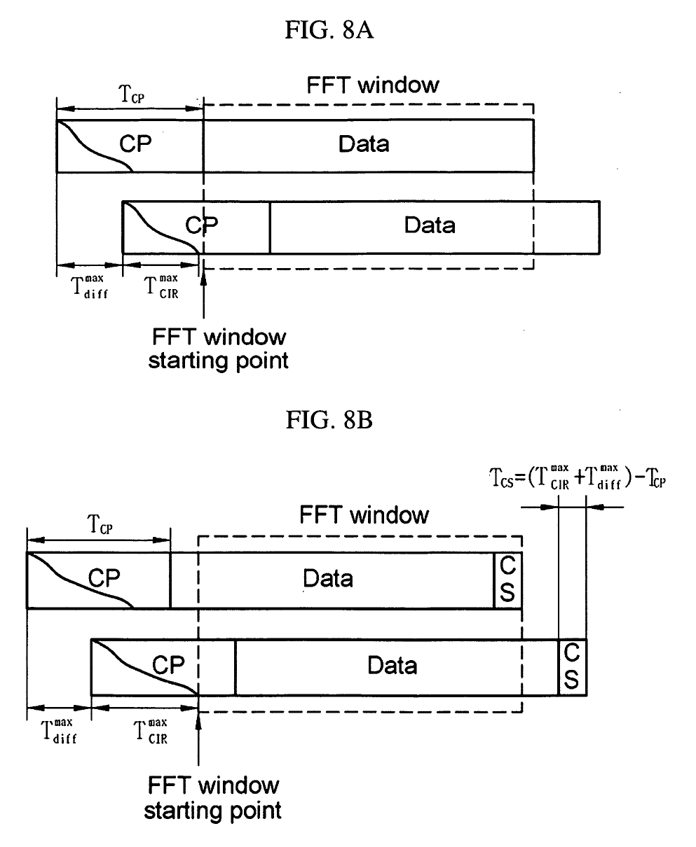

FIG. 8A is a diagram illustrating an FFT window start point of Embodiment 4. FIG. 8B is a diagram illustrating an FFT window start point of Embodiment 5. In order to be able to restore a data signal without the effects of ISI and ICI, Embodiment 4 and Embodiment 5 need to detect an accurate FFT window start point.

Referring to FIG. 8A, where a CS is not inserted in Embodiment 4, the AP and each SS sets an FFT window start point in accordance with a data start point of the first-received signal among received signals. Referring to FIG. 8B, where a CS is inserted in Embodiment 5, the AP and each SS sets an FFT window start point in accordance with a point delayed by the T_{CS} length that is the CS length inserted at a data start point of the first-received signal among received signals.

Hereinafter, a description will be given of an experimental example and the resulting effect.

Schemes according to the exemplary embodiments are compared with the related art FDD and TDD schemes. Table 1 below illustrates parameters that are used to compare the resource efficiency of the schemes according to the exemplary embodiments with the resource efficiency of the related art FDD and TDD schemes. Parameters such as frequency band, guard interval length, subcarrier interval, FFT, frequency band used are identical to those of IEEE 802.11a used in an indoor wireless LAN. Referring to Table 1, a Transmit/receive Transition Gap (TTG) and a Receive/transmit Transition Gap (RTG) is set to 5 μs in consideration of a TX-to-RX transition time, an RX-to-TX transition time, and a Round Trip Delay (RTD). A guard band is set in consideration of the subcarrier interval and the number of guard subcarriers, and a channel impulse response length is set to 0.8 μs equal to the CP length.

TABLE 1

| Parameter | Value | |
|---|---|---|
| Cell Radius | 20 | m |
| Bandwidth (BW) | 20 | MHz |
| Guard Band | 3.75 MHz | |
| | (0.3125 MHz*12) | |
| Guard Interval Length (CP) | 0.8 | μs |
| Subcarrier Interval | 0.3125 MHz | |
| | (20 MHz/64) | |
| OFDM Symbol Length | 3.2 | μs |
| Frame Length | 100 | μs |
| TTG | 5.132 | μs |
| RTG | 5 | μs |
| Mutual Ranging Symbol Length | 4.8 | μs |
| FFT | 64 | |
| SDD Transmission Scheme | Embodiment 3 | |
| Channel Impulse Response Length | 0.8 | μs |

The resource efficiency of the FDD scheme calculated using the parameters of Table 1 may be expressed as Equation (10) below.

$$\begin{matrix}{CE}_{FDD} = \frac{{C}_{FDD}}{{C}_{Ideal}} \times 100 \\ = \frac{( BW - {F}_{Guard} ) \cdot ( {T}_{frame} - {N}_{sym} \cdot {T}_{CP} )}{BW \cdot {T}_{frame}} \times 100 \\ = \frac{( 20 - 3.75 ) \times ( 100 - ( 100 / 4 ) \times 0.8 )}{20 \times 100} \times 100 \\ = 65.00 \%\end{matrix} \qquad ( 10 )$$

where CE_{FDD} denotes the resource efficiency of the FDD scheme, i.e., 65.00%, C_{FDD} denotes the resource amount of the FDD scheme, C_{ideal} denotes the resource amount of an ideal case, BW denotes the bandwidth, F_{Guard} denotes the guard band, T_{frame} denotes the length of one frame, and N_{sym} denotes the number of symbols in one frame.

The resource efficiency of the TDD scheme may be expressed as Equation (11) below.

$$\begin{matrix}{CE}_{TDD} = \frac{{C}_{TDD}}{{C}_{Ideal}} \times 100 \\ = \frac{BW ( {T}_{frame} - ( {N}_{sym} \cdot {T}_{CP} ) - {T}_{TTG} - {T}_{RTG} )}{BW \cdot {T}_{frame}} \times 100 \\ = \frac{20 \times ( 100 - ( 100 / 4 ) \times 0.8 - 5.132 - 5 )}{20 \times 100} \times 100 \\ = 69.87 \%\end{matrix} \qquad ( 11 )$$

where CE_{TDD} denotes the resource efficiency of the TDD scheme, i.e., 69.87%, C_{TDD} denotes the resource amount of the TDD scheme, T_{TTG} denotes the length of the TTG, and T_{RTG} denotes the length of the RTG.

The resource efficiency of Embodiment 4 may be expressed as Equation (12) below. Herein, the CS length is set to 0.

$$\begin{matrix}{CE}_{SDD} = \frac{{C}_{SDD}}{{C}_{Ideal}} \times 100 \\ = \frac{BW ( {T}_{frame} - {N}_{sym} \cdot ( {T}_{CP} + {T}_{CS} ) - {T}_{Mutual} )}{BW \cdot {T}_{frame}} \times 100 \\ \approx \frac{BW ( {T}_{frame} - {N}_{sym} \cdot ( {T}_{CP} + {T}_{CS} ) )}{BW \cdot {T}_{frame}} \times 100 \\ = \frac{20 \times ( 100 - ( 100 / 4 ) \times ( 0.8 + 0 ) )}{20 \times 100} \times 100 \\ = 80.00 \%\end{matrix} \qquad ( 12 )$$

The resource efficiency of Embodiment 5 may be expressed as Equation (13) below.

$$\begin{matrix}{CE}_{SDD} = \frac{{C}_{SDD}}{{C}_{Ideal}} \times 100 \\ = \frac{BW ( {T}_{frame} - {N}_{sym} \cdot ( {T}_{CP} + {T}_{CS} ) - {T}_{Mutual} )}{BW \cdot {T}_{frame}} \times 100 \\ \approx \frac{BW ( {T}_{frame} - {N}_{sym} \cdot ( {T}_{CP} + {T}_{CS} ) )}{BW \cdot {T}_{frame}} \times 100 \\ = \frac{20 \times ( 100 - ( 100 / 4.132 ) \times ( 0.8 + 0.132 ) )}{20 \times 100} \times 100 \\ = 77.44 \%\end{matrix} \qquad ( 13 )$$

where the CS length is set in consideration of the delay time difference (2T=2R×3.3[ns/m]=0.132[μs]). Because the mutual ranging process is performed in a long period in the exemplary embodiment, the resource efficiency degradation due to the mutual ranging symbol may be disregarded. CE_{SDD} denotes the resource efficiency of the exemplary embodiment. CE_{SDD} is 80% in the case of not using the CS and is 77.44% in the case of using the SC. C_{SDD} denotes the resource amount of the exemplary embodiment, and T_{Mutual} denotes the length of the mutual ranging symbol.

As can be seen from Equations (10) to (13), the resource efficiencies (80.00% and 77.44%) of the exemplary embodiments are higher than the resource efficiency (65%) of the FDD scheme and the resource efficiency (69.87%) of the TDD scheme.

Hereinafter, the performance of the mutual ranging used in an exemplary embodiment is analyzed through a simulation. The arrangement structure of the AP and each SS used in the simulation is identical to that illustrated in FIG. 5. Parameters used in the simulation are illustrated in Table 2.

TABLE 2

| Parameter | Value | |
|---|---|---|
| Carrier Frequency (fc) | 5 | GHz |
| Bandwidth (BW) | 20 | MHz |
| FFT | 64 | |
| OFDM Symbol Length | 3.2 μs/64 sample | |
| Guard Interval Length (CP) | 0.8 μs/16 sample | |
| Guard Interval Length (CS) | 0.8 μs/16 sample | |
| Subcarrier used (including Pilot and DC) | 52 | |
| Number of SSs | 3 | |
| Cell Radius | 20 | m |
| T SS1, SS2 = T SS2, SS1 | 3 | sample |
| T SS1, SS3 = T SS3, SS1 | 2 | sample |
| T SS2, SS3 = T SS3, SS2 | 2 | sample |

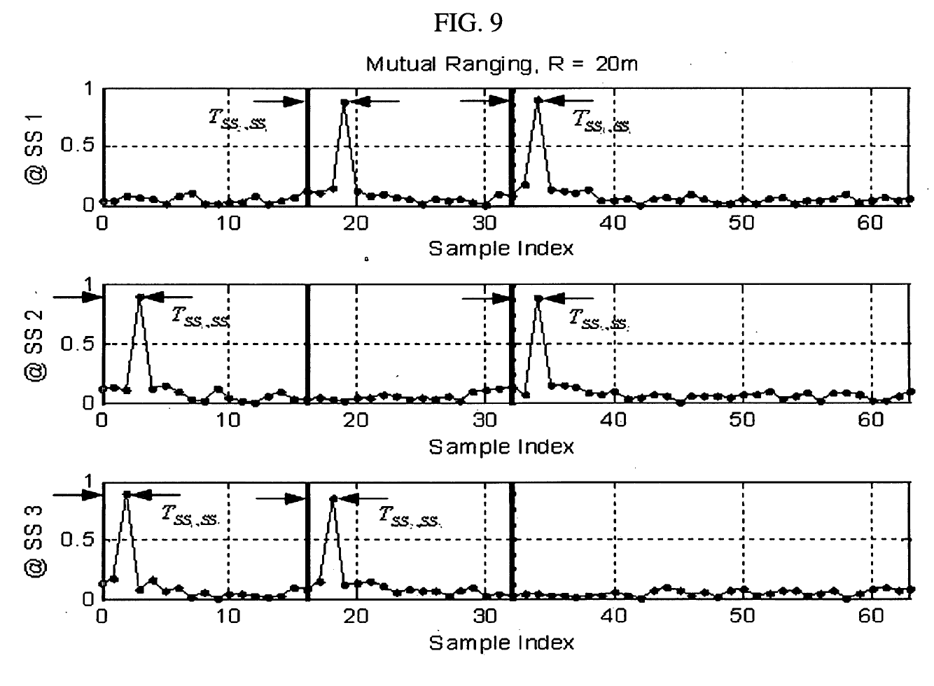

FIG. 9 is a diagram illustrating estimation of a mutual delay time between each SS and another SS on the basis of a mutual ranging symbol according to an exemplary embodiment.

Referring to FIG. 9, a mutual delay time between each SS and another SS may be estimated by detecting the degree of an additional circular shift with respect to the circular shift of a time-domain channel impulse response according to the specific phase rotation information of another SS (SS 1=0, SS 2=16, SS 3=32). The SS 1 estimates the delay time with the SS 2 to be 3 samples, and estimates the delay time with the SS 3 to be 2 samples. The SS 2 estimates the delay time with the SS 1 to be 3 samples, and estimates the delay time with the SS 3 to be 2 samples. Also, the SS 3 estimates the delay time with the SS 1 to be 2 samples, and estimates the delay time with the SS 2 to be 2 samples. It can be seen from the comparison with the delay times of Table 2 that each SS may accurately estimate the delay time with another SS.

The above-described functions, methods and/or operations may be executed by processors such as microprocessors, controllers, microcontrollers, and application specific Integrated circuits (ASICs), which are based on software or program codes that are coded to execute the functions. It is understood that the design, development and implementation of the codes are apparent from the above description to those skilled in the art.

According to certain embodiment described above, a duplexing delay may be prevented by simultaneously transmitting UL/DL signals. Certain embodiments disclosed above may flexibly cope with a data traffic change in the UL/DL links by flexibly allocating the UL/DL resources and/or increase the resource efficiency without causing ISI and ICI. In comparison with the related art FDD scheme, an exemplary embodiment described above may simultaneously transmit UL/DL signals without using a guard band, and may cope with a data traffic change more flexibly by allocating UL/DL signals to each subcarrier of the OFDMA symbol. In comparison with the related art TDD scheme, an exemplary embodiment may not require the TTG and the RTG and may cope with a traffic change flexibly. As compared to the Zipper scheme (i.e., a kind of wired transmission scheme), an exemplary embodiment may receive and control a signal of another SS. Accordingly, the optimal CS length may be set after determining whether to insert the CS. Thus, a higher data efficiency may be provided by using a smaller CP length than the Zipper scheme.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A synchronization method comprising:
transmitting a first mutual ranging symbol to at least one other subscriber station;
receiving a second mutual ranging symbol from the other subscriber station; and
controlling uplink synchronization information on the basis of the second mutual ranging symbol.

2. The synchronization method of claim 1, further comprising:
performing an uplink synchronization with an access point before the transmitting of the first mutual ranging symbol.

3. The synchronization method of claim 1, further comprising:
determining whether to insert a cyclic suffix in an Orthogonal Frequency Division Multiplexing (OFDM) symbol for data transmission on the basis of the controlled uplink synchronization information.

4. The synchronization method of claim 3, wherein the OFDM symbol is configured to duplex a subcarrier for uplink transmission and a subcarrier for downlink transmission.

5. The synchronization method of claim 1, wherein the mutual ranging symbol includes a plurality of preamble sequences, a cyclic prefix, and a cyclic suffix, or includes a preamble sequence, a cyclic prefix, and a cyclic suffix.

6. The synchronization method of claim 5, wherein the first mutual ranging symbol and the second mutual ranging symbol are different in terms of the preamble sequence constituting the mutual ranging symbol.

7. The synchronization method of claim 1, further comprising:
receiving timing information, for transmission of the first mutual ranging symbol, from an access point.

8. The synchronization method of claim 3, further comprising:
transmitting data through the OFDM symbol,
wherein the data are transmitted by performing a timing advance from an absolute time by the delay time with an access point on the basis of the controlled uplink synchronization information.

9. The synchronization method of claim 3, further comprising:
transmitting data through the OFDM symbol,
wherein the data are transmitted at a signal receiving time from an access point on the basis of the controlled uplink synchronization information.

10. The synchronization method of claim 3, further comprising:
transmitting data through the OFDM symbol,
wherein the data are transmitted by performing a variable timing advance on the basis of the controlled uplink synchronization information to minimize the maximum value of a delay time between an access point and the subscriber station according to an intra-cell environment.

11. The synchronization method of claim 3, wherein if the sum of the maximum delay value of a channel impulse response, which is the largest one of channel impulse response lengths between an access point and the subscriber station and between the subscriber station and other subscriber stations, and the maximum value of a mutual delay time, which is the maximum mutual time delay difference, is smaller than or equal to a cyclic prefix length, the cyclic suffix is not to be inserted in the OFDM symbol; and if not, the cyclic suffix is to be inserted in the OFDM symbol.

12. The synchronization method of claim 11, wherein if the cyclic suffix is to be inserted in the OFDM symbol, a cyclic suffix with a length corresponding to the difference between the cyclic prefix length and the sum of the maximum delay value of the channel impulse response and the maximum value of the mutual delay time is inserted in the OFDM symbol.

13. A data receiving method comprising:
performing initial ranging with a subscriber station to acquire uplink synchronization; and
receiving uplink data from the subscriber station,
wherein the uplink data are transmitted using uplink synchronization information controlled by exchanging mutual ranging symbols between intra-cell subscriber stations.

14. The data receiving method of claim 13, further comprising:
determining whether to insert a cyclic suffix in an Orthogonal Frequency Division Multiplexing (OFDM) symbol for data transmission on the basis of the controlled uplink synchronization information.
